(19) United States
(12) Patent Application Publication
(10) Pub. No.: US 2015/0375723 A1
(43) Pub. Date: Dec. 31, 2015

(54) Hydraulic Unit for a Slip Control System of a Hydraulic Vehicle Brake System

(71) Applicant: Robert Bosch GmbH, Stuttgart (DE)

(72) Inventors: Matthias Hurst, Immenstadt (DE); Andreas Weh, Sulzberg (DE)

(21) Appl. No.: 14/751,448

(22) Filed: Jun. 26, 2015

(30) Foreign Application Priority Data
Jun. 27, 2014 (DE) 10 2014 212 385.2

(51) Int. Cl. B60T 8/40; F04B 49/22

(52) U.S. Cl. CPC B60T 8/4068; F04B 49/22

(57) ABSTRACT

A hydraulic unit for a slip control system of a hydraulic vehicle brake system includes a pressure change damper arranged radially with respect to a piston pump and laterally to the outside of an intake valve on one valve side of a hydraulic block of the hydraulic unit. The hydraulic unit has hydraulically separate annular channels that surround the piston pump. The pressure change damper has an inlet and an outlet that issue into the hydraulically separate annular channels.

This application claims priority under 35 U.S.C. §119 to patent application no. DE 10 2014 212 385.2, filed on Jun. 27, 2014 in Germany, the disclosure of which is incorporated herein by reference in its entirety.

### BACKGROUND

The disclosure relates to a hydraulic unit for a slip control system of a hydraulic vehicle brake system.

Slip control systems of hydraulic vehicle brake systems have hydraulic units with hydraulic components for slip control. Such hydraulic components are solenoid valves, check valves, hydraulic pumps, hydraulic accumulators, damper chambers and restrictors. For mechanical fastening and hydraulic interconnection of the hydraulic components, such hydraulic units have hydraulic blocks. The hydraulic blocks are normally cuboidal flat blocks made of metal, e.g. an aluminum alloy. Sockets for the hydraulic components are formed in the hydraulic blocks, typically being embodied as blind holes of stepped diameter into which the hydraulic components are inserted, pressed or installed in some other way and fastened, for example, by swaging. Lines are produced by drilling the hydraulic block, said lines extending predominantly parallel to edges of the hydraulic block, i.e. in a Cartesian pattern, and hydraulically interconnecting the sockets and the hydraulic components installed therein. A hydraulic block equipped with the hydraulic components for slip control can be understood as a hydraulic unit. The hydraulic block or hydraulic unit is connected to a brake master cylinder by brake lines, and hydraulic wheel brakes are connected to the hydraulic unit or hydraulic block by brake lines.

European Patent EP 1 623 118 B1 discloses a hydraulic block of this kind having a socket for a piston pump, in which a piston pump is arranged, and having a socket for a pressure change damper, in which a pressure change damper is arranged. The pressure change damper is used to damp pressure surges, pressure pulsation and pressure oscillations of brake fluid at an outlet of the piston pump. The piston pump has an encircling annular groove, which forms an annular channel surrounding the piston pump in the socket for the piston pump in the hydraulic block. Issuing into the annular channel are the outlet of the piston pump and a brake fluid line, which is embodied as a hole in the hydraulic block and issues radially into the socket for the piston pump and coaxially into a bottom of the socket for the pressure change damper. The pressure change damper of the known hydraulic unit does not have any other connection. The piston pump has two further encircling grooves, which form annular channels in the socket in the hydraulic block and are separated from one another by radial flanges. The radial flanges have apertures, thus forming mechanical filters. By means of the apertures in the radial flanges, the annular channels surrounding the piston pump in the socket of the hydraulic block communicate with one another.

### SUMMARY

In the hydraulic block of the hydraulic unit according to the disclosure, the socket for the piston pump and the piston pump arranged in the socket form two hydraulically separate annular channels which surround the piston pump. The annular channels can be formed by encircling grooves in the piston pump and/or the socket for the piston pump in the hydraulic block and/or by axially spaced diameter steps on the piston pump and the socket for the piston pump, and the two annular channels can be separated hydraulically from one another by a radial flange of the piston pump and/or of the socket for the piston pump. This list is used to illustrate individual embodiment options and is not exhaustive.

One of the two annular channels surrounding the piston pump in the socket of the hydraulic block communicates with an outlet of the piston pump and with an inlet of the pressure change damper. The other annular channel communicates with an outlet of the pressure change damper and with a brake fluid line in the hydraulic block, which connects solenoid valves, namely an isolation valve and two pressure buildup valves of the slip control system.

The disclosure connects an inlet of the pressure change damper to the slip control system of a hydraulic vehicle brake system in a manner hydraulically separated from an outlet of the pressure change damper. This ensures that brake fluid which is delivered by the piston pump flows through the pressure change damper, improving a damping effect. Any leakage between the two annular channels surrounding the piston pump in the socket in the hydraulic block is harmless because, despite any such leakage, by far the greater part of the brake fluid delivered by the piston pump flows through the pressure change damper and because any leakage flow from one annular channel into the other is also highly restricted and thereby damped by a possible small and slit-shaped leakage passage area between the piston pump and the socket of said pump in the hydraulic block.

The dependent claims relate to advantageous embodiments and developments of the disclosure.

In a preferred embodiment of the disclosure, the pressure change damper is arranged on the hydraulic block radially with respect to the piston pump or with a parallel offset relative to a radial line of the piston pump. This arrangement can also be expressed in such a way that a virtual extension of the socket for the pressure change damper intersects the socket for the piston pump in the hydraulic block. The pressure change damper is preferably arranged on the hydraulic block to the outside of a solenoid valve, namely an intake valve, of the slip control system. This arrangement can be implemented by making the socket for the pressure change damper on an existing hydraulic block, i.e. with a small modification and little effort. It allows a pressure change damper which projects from the hydraulic block and therefore allows a large volume of the pressure change damper, which contributes to the damping effect. Moreover, this embodiment of the disclosure enables the pressure change damper to be arranged on a “valve side” of a hydraulic block, i.e. on the side of a hydraulic block on which the solenoid valves of the slip control system are arranged and on which valve domes of the solenoid valves project. This allows a space-saving and compact embodiment of the hydraulic unit according to the disclosure.

The pressure change damper can be arranged on the hydraulic block radially with respect to the piston pump or with a parallel offset relative to a radial line of the piston pump, and the piston pump and the pressure change damper are arranged between an isolation valve on one side and a pressure buildup valve or a row of pressure buildup valves on the other side. Typically, a pressure lowering valve or a row of pressure lowering valves is arranged between the pressure buildup valve or valves and the piston pump and the pressure change damper. The development provides a brake fluid line which connects the piston pump to the pressure buildup valves. Via the isolation valve or an isolation valve in each brake circuit, the hydraulic unit is connected to a brake master cylinder. Wheel brakes are connected to the hydraulic unit via the pressure buildup and pressure lowering valves.

### BRIEF DESCRIPTION OF THE DRAWINGS

The disclosure is explained in greater detail below by means of an embodiment illustrated in the drawings, in which:

FIG. 1 shows a section through one half of a hydraulic unit according to the disclosure; and

FIG. 2 shows a hydraulic block of the hydraulic unit from FIG. 1 according to the disclosure in a perspective view.

### DETAILED DESCRIPTION

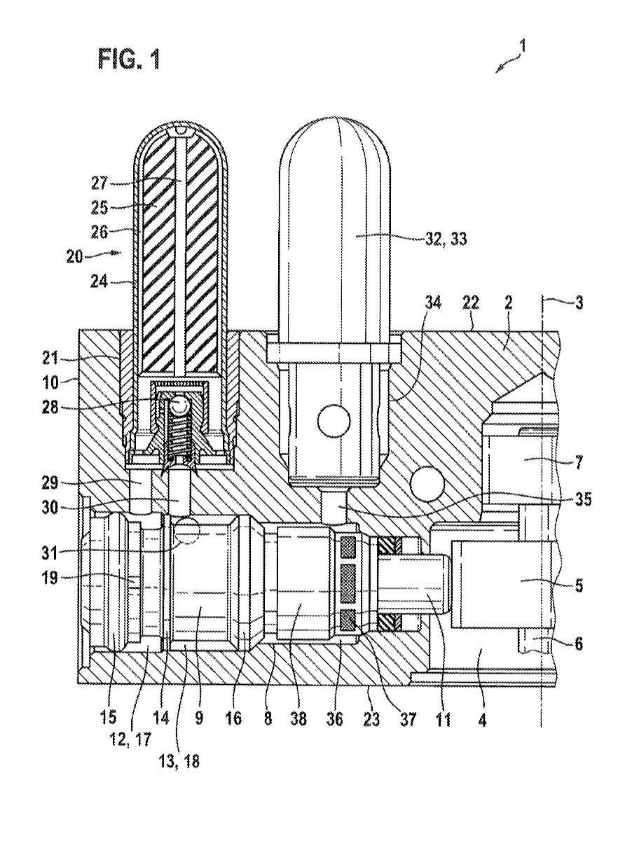

The hydraulic unit 1 according to the disclosure, which is shown in FIG. 1, is part of a slip control system (otherwise not shown) of a hydraulic vehicle brake system. Such slip control systems are known, serving for antilock, traction control and/or vehicle dynamics or antiskid control. The abbreviations ABS, ASR, FDR and ESP are customary for these control systems.

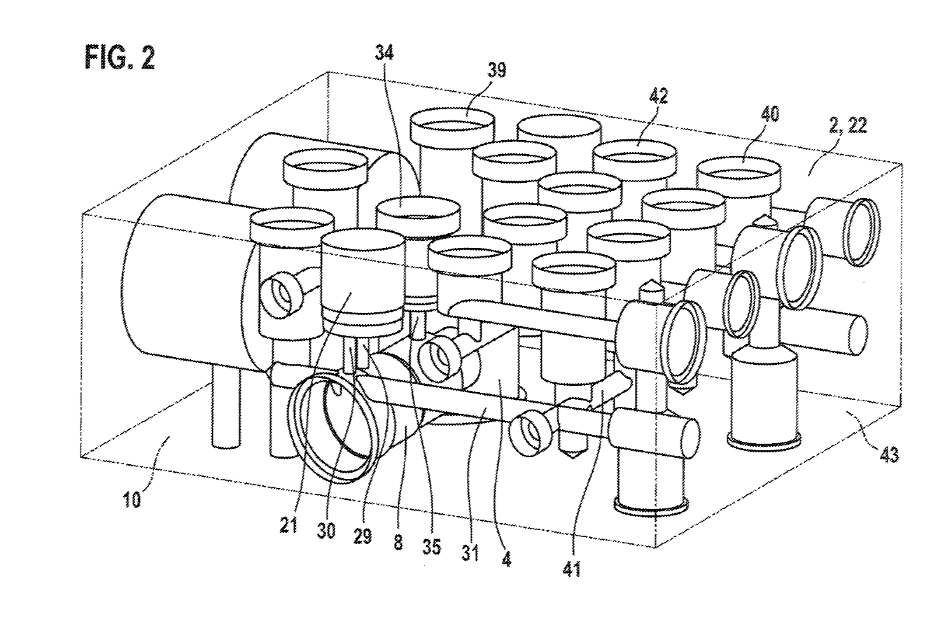

The hydraulic unit 1 has the cuboidal hydraulic block 2 shown in FIG. 2, which consists, for example, of an aluminum alloy and has been machined. In FIG. 2, the hydraulic block 2 is shown as transparent in order to show the drilling thereof, and it is shown unequipped in FIG. 2, i.e. without the hydraulic components explained below. In elevation, the hydraulic block 2 is rectangular, almost square, and it is flat, namely approximately ¼ to ⅓ as thick as it is long or wide. The drawing shows a section through one half of the hydraulic block 2 on one side of a longitudinal center plane 3, with respect to which the hydraulic block 2 is symmetrical. In the longitudinal center 3, virtually centrally, the hydraulic block 2 has a countersink of stepped diameter as an eccentric space 4, in which an eccentric 5 is arranged. The eccentric 5 is arranged eccentrically on an eccentric shaft 6, which is mounted rotatably in the hydraulic block 2 by means of a ball bearing 7. An axis of the eccentric shaft 6 is situated in the center plane 3 of the hydraulic block 2. The eccentric shaft 6 can be driven in rotation by means of an electric motor (not shown) mounted on the hydraulic block 2, thereby enabling the eccentric 5 to be driven to perform a movement on a circular path around the eccentric shaft 6.

A socket 8 for a piston pump 9 is made in the hydraulic block 2 radially with respect to the eccentric space 4. The socket 8 is a through hole of stepped diameter, which is open on one longitudinal side 10 of the hydraulic block 2 and issues into the eccentric space 4. The longitudinal side 10 of the hydraulic block 2 extends parallel to longitudinal center plane 3 of the hydraulic block 2. An axis of the socket 8 for the piston pump 9 is situated in a radial center plane of the eccentric 5. A pump piston 11 of the piston pump 9 is pressed against a circumference of the eccentric 5 by a piston spring, which is situated in the interior of the piston pump 9 and is therefore not visible in the drawing, with the result that the pump piston 11 is driven to perform a stroke motion, by means of which the piston pump 9 delivers brake fluid in a manner known per se, during the rotary driving described of the eccentric 5. The piston pump 9, which can also be interpreted as a hydraulic pump of the slip control system, is used for a brake pressure buildup and for delivering brake fluid, which has been released from wheel brakes in order to lower a braking force, for a renewed brake pressure buildup in the wheel brakes or to deliver brake fluid in the direction of a brake master cylinder (not shown). Such piston pumps 9 or hydraulic pumps of slip control systems of hydraulic vehicle brake systems are also referred to as return pumps.

The piston pump 9 has two adjacent encircling grooves 12, 13, which are separated from one another by a radial flange 14 and are bounded on opposite sides by radial flanges 15, 16. The radial flanges 14, 15, 16 rest on a circumferential wall of the socket 8 for the piston pump 9 in the hydraulic block 2, with the result that two annular channels 17, 18 are formed in the socket 8, which surround the piston pump 9 and are separated hydraulically from one another by the radial flange 14 situated between them. Outlets 19 of the piston pump 9, which are arranged in a manner distributed over a circumference of the piston pump 9, issue into one of the two annular channels 17. In the embodiment of the disclosure which is shown, the outlets 19 of the piston pump 9 issue into the annular channel 17 of the two annular channels 17, 18 which is closer to the longitudinal side 10 of the hydraulic block 2.

In an axial plane of the piston pump 9, the hydraulic unit 1 has a pressure change damper 20. The pressure change damper 20 is arranged in a socket 21, which is made as a cylindrical blind hole in a flat side of the hydraulic block 2, here referred to as valve side 22. The valve side 22 is situated opposite a flat side of the hydraulic block 2, which is referred to here as motor side 23, on which the eccentric space 4 opens and on which the electric motor (not shown) for driving the eccentric 5 is mounted.

The pressure change damper 20 has a housing 24 in the form of a cylindrical tube, which is open at the bottom of the socket 21 in the hydraulic block 2 and is closed on another side in the form of a hemisphere. The damper housing 24 projects from the hydraulic block 2 on the valve side 22. Arranged in the damper housing 24 is a damper body 25 made from an elastomer, which has axially parallel grooves 26 on the outside and an axial through hole 27. Moreover, the pressure change damper 20 in the embodiment of the disclosure which is shown has a check valve 28 at one outlet, which controls a direction of flow through the pressure change damper 20. The check valve 28 is likewise accommodated in the damper housing 24 although it is not absolutely essential but can be omitted in some embodiments of the disclosure, it being possible for a check valve to be provided at the inlet of the pressure change damper 20 (not shown) instead of or in addition to the check valve 28 at the outlet.

A brake fluid line 29 embodied as a hole in the hydraulic block 2 extends in an axially parallel manner with respect to the pressure change damper 20 and issues radially into the socket 8 for the piston pump 9, more specifically into annular channel 17, with which the outlets 19 of the piston pump 9 communicate. By means of the brake fluid line 29, the outlets 19 of the piston pump 9 communicate with an inlet of the pressure change damper 20. The brake fluid line 29 issues eccentrically, close to a circumference, at a bottom of the socket 21 for the pressure change damper 20 in the hydraulic block 2.

A second brake fluid line 30 extends axially or likewise in an axially parallel manner relative to the pressure change damper 20 from the bottom of the socket 21 for the pressure change damper 20 in the hydraulic block 2 to the socket 8 for the piston pump 9, into which it issues radially, into the other annular channel 18, which surrounds the piston pump 9 in socket 8. The second brake fluid line 30 communicates with an outlet of the pressure change damper 20. An eccentric arrangement of the second brake fluid line 30 close to a circumference of the socket 21 for the pressure change damper 20 simplifies bleeding of the pressure change damper 20 during filling of the hydraulic unit 1 with brake fluid. The hydraulic separation of the inlet and the outlet of the pressure change damper 20 ensures that brake fluid delivered by the piston pump 9 flows through the pressure change damper 20. In the pressure change damper 20, the brake fluid flows through the grooves 26 in the outside of the damper body 25 and then through the axial through hole 27, thus ensuring good damping of pressure surges, pressure pulsation and pressure oscillations in brake fluid at the outlet of the piston pump 9.

The socket 8 for the piston pump 9 is penetrated by a brake fluid line 31, which is made as a hole in the hydraulic block 2 parallel to edges, to the longitudinal center plane 3, to the longitudinal side 10, to the valve side 22 and to the motor side 23. In this embodiment, brake fluid line 31 is formed eccentrically, close to a circumference of the socket 8 for the piston pump 9 in the hydraulic block 2, although brake line 21 can be formed further out than illustrated or closer to the center or radially with respect to socket 8 in the hydraulic block 2. Brake fluid line 31 passes through the annular channel 18 surrounding the piston pump 9 into which the outlets 19 of the piston pump 9 do not issue but which is separated hydraulically from the outlets 19 of the piston pump 9 and from the inlet of the pressure change damper 20 by radial flange 14. Brake line 31 connects a socket 39 for an isolation valve (not shown) to a socket 40 for a pressure buildup valve (likewise not shown) of the slip control system of the hydraulic vehicle brake system. The isolation valve is a solenoid valve by means of which the slip control system is connected to a brake master cylinder (not shown). For connection, the hydraulic block 2 is connected by means of a brake line to the brake master cylinder. By closing the isolation valve, the brake master cylinder can be separated hydraulically from the vehicle brake system during a slip control operation. The socket 8 for the piston pump 9, the socket 21 for the pressure change damper 20 and a socket 34 for an intake valve 32 still to be explained, which are arranged in a plane parallel to transverse sides 43 of the hydraulic block 2, are arranged between the socket 39 for the isolation valve, on the one hand, and the socket 40 for the pressure buildup valve, on the other.

The pressure buildup valves are likewise solenoid valves, by means of which wheel brakes (not shown) are connected to the slip control system, more specifically likewise via brake lines connected to the hydraulic block 2. By means of brake fluid line 31, the outlet of the pressure change damper 20 communicates with the isolation valve and the pressure buildup valves of the slip control system of the hydraulic vehicle brake system. Four sockets 40 for four pressure buildup valves, two for each brake circuit, are made in the hydraulic block 2 in a row parallel to a transverse side of said block, and are connected in each brake circuit by a transverse hole 41. Four sockets 42 for pressure lowering valves (not shown) are made adjacent to one another in a row in the hydraulic block 2, between the sockets 40 for the pressure buildup valves and the sockets 9 for the piston pumps 8.

The intake valve 32, which is likewise embodied as a solenoid valve, is arranged on the hydraulic block 2 between the pressure change damper 20 and the eccentric space 4. The intake valve 32 is arranged parallel to the pressure change damper 20, i.e. in an axial plane relative to the piston pump 9 and parallel to the eccentric shaft 6. A valve dome 33 of the intake valve 32 projects from the hydraulic block 2 on the valve side 22, like the pressure change damper 20 and the other solenoid valves (not shown) of the slip control system. The intake valve 32 is arranged in socket 34, which is embodied as a blind hole in the valve side 22 of the hydraulic block 2. A brake fluid line 35, which is embodied as a hole in the hydraulic block 2, leads from a bottom of socket 34 into the socket 8 for the piston pump 9. Brake fluid line 35 leads into an annular space 36, which surrounds the piston pump 9 in socket 8. In this annular space 36 there is an inlet of the piston pump 9. An inlet is provided by filter apertures 37 in a tubular filter 38, which is mounted on the piston pump 9. The filter apertures 37 are provided with a filter fabric or the like. By means of the intake valve 32, the inlet of the piston pump 9 can be connected to the brake master cylinder (not designated).

The pressure change damper 20 is arranged in a space-saving manner laterally to the outside of the intake valve 32, i.e. between the longitudinal side 10 of the hydraulic block 2 and the intake valve 32. As already stated, the pressure change damper 20 and the intake valve 32 are arranged on the hydraulic block 2 in an axial plane of the piston pump 9. However, the pressure change damper 20 and/or the intake valve 32 can also be arranged offset in parallel to such an extent that virtual extensions of their sockets 21, 34 enter the socket 8 for the piston pump 9. The sockets 21, 34 of the pressure change damper 20 and the intake valve 32 are made in such a way in the hydraulic block 2 that the brake fluid lines 29, 30, 35, which issue into the socket 8 for the piston pump 9, can be embodied as axial or axially parallel holes in the bottom of the socket 21, 34 for the pressure change damper 20 and the intake valve 32.

What is claimed is:

1. A hydraulic unit for a slip control system of a hydraulic vehicle brake system, comprising:
a hydraulic block defining a first socket and a second socket;
a pressure change damper arranged in the second socket; and
a piston pump arranged in the first socket, the first socket and the piston pump configured to form two hydraulically separate annular channels that surround the piston pump, wherein a first annular channel of the two hydraulically separate annular channels communicates with an outlet of the piston pump and with an inlet of the pressure change damper, and
wherein a second annular channel of the two hydraulically separate annular channels communicates with an outlet of the pressure change damper and with a brake fluid line in the hydraulic block that connects an isolation valve to pressure buildup valves of the slip control system.

2. The hydraulic unit according to claim 1, wherein the piston pump has two encircling grooves configured to form the annular channels in the first socket of the hydraulic block.

3. The hydraulic unit according to claim 1, wherein the hydraulic block has at least one brake fluid line that (i) connects one of the two annular channels in the first socket to a bottom of the second socket and (ii) issues eccentrically into the bottom of the second socket.

4. The hydraulic unit according to claim 3, wherein the at least one brake fluid line issues at a circumference of the bottom of the second socket in the hydraulic block.

5. The hydraulic unit according to claim 1, wherein the pressure change damper is arranged radially with respect to the piston pump.

6. The hydraulic unit according to claim 1, further comprising an intake valve of the slip control system, the intake valve arranged in a third socket defined by the hydraulic block, wherein:
a virtual extension of the second socket intersects the first socket in the hydraulic block,
the pressure change damper is arranged on the hydraulic block to the outside of the intake valve, and
a virtual extension of the third socket intersects the first socket and communicates with an inlet of the piston pump.

7. The hydraulic unit according to claim 1, wherein:
the isolation valve is arranged in a third socket defined by the hydraulic block and one of the pressure buildup valves is arranged in a fourth socket defined by the hydraulic block,
a virtual extension of the second socket intersects the first socket in the hydraulic block, and
the first socket and the second socket are arranged between the third socket and the fourth socket in the hydraulic block.

8. The hydraulic unit according to claim 7, wherein the hydraulic block has a brake fluid line that passes through the first socket and connects the first socket to the third socket and the fourth socket.
